(19) United States
(12) Patent Application Publication
(10) Pub. No.: US 2004/0059920 A1
(43) Pub. Date: Mar. 25, 2004

(54) Security health checking tool

(75) Inventor: Debbie Ann Godwin, Rogers, TX (US)

Correspondence Address: Robert H. Frantz, P.O. Box 23324, Oklahoma City, OK, 73123, US

(73) Assignee: International Business Machines Corporation, Armonk, NY

(21) Appl. No.: 10/246,969

(22) Filed: Sep. 19, 2002

(51) Int. Cl. H04L 9/00

(52) U.S. Cl. 713/183

(57) ABSTRACT

A tool for checking storage management system security settings which accesses one or more security parameters, compares them to security policies, rules, and allowable values, and reports noncompliant settings via a user-readable report. A set of automatic correction rules may be employed to automatically modify noncompliant settings to bring them into compliance, which actions may also be reported in the user-readable report.

### BACKGROUND OF THE ART

1. Field of the Invention

This invention relates to but is not limited to the fields of web server security management systems and tools.

2. Background of the Art

Many Internet or web servers are provided with security systems to prevent unauthorized users from accessing protected data, changing system settings, and uploading pages, graphics, and other web objects. For security systems to be effective in their role to protect the content and functionality of a web server, only authorized persons, such as system administrators, must be allowed certain privileges such as these abilities.

As many web servers are administered remotely, physical access restrictions such as access control to server rooms, keyboard locks, etc., are not applicable. For these remotely administered systems, online security systems have been developed which allow for sophisticated user authorization and authentication processes, secure communications protocols, and a high degree of data integrity between a remote administrator and a web server.

Online storage of data has proliferated as online servers have become more affordable and secure. Through the use of online storage systems, companies and individuals may store “original” or “working” copies on servers which are accessible via Internet and/or intranet servers. Additionally, “backup” copies of such data may be stored online. By utilizing online storage of data, users and programs may access the data from anywhere accessible to the storage server. By utilizing online backup systems, losses of primary data storage can be recovered to any server or system which accessible to the computer network, allowing recovery centers to be located anywhere in the world.

Automation and tools for the management of such online storage has progressed as the demand and usage of such systems has become wide spread. On such product is Tivoli Storage Manager (“TSM”), formerly known as the ADSTAR Distributed Storage Management (“ADSM”), product from International Business Machines (“IBM”).

TSM allows a user or system administrator to manage online storage devices such as personal computer (“PC”) disk drives, Iomega's ZIP [TM] drives, and mainframe computer storage. Companies of any size can determine schedules, policies and authorities for backing up, accessing, modifying, and restoring data from or to any of the storage devices within the enterprise. TSM is useful for managing a wide array of storage formats, hardware platforms, file systems, and databases. By using TSM, users can avoid management and tracking of backup tapes and disks at a multiplicity of individual locations and sites. All systems which are in an enterprise or network may be managed by TSM, backed up, and recovered, depending on system administrators' preferences and authorizations.

TSM's functionality, however, extends beyond basic backup and restore functions, but allows protection, integrity assurance, and availability of the e-Business data for an enterprise, as well as application program protection.

Products with similar functionality and objectives are available from companies such as:

(a) hardware server and storage original equipment manufacturers including

EMC, Compaq, Hitachi, IBM, Dell, Hewlett-Packard, Sun

Microsystems, and Network Appliance;

(b) storage connectivity products from Brocade, McDATA, QLogic and Emulex; and

(c) and storage management software from Veritas, IBM's Tivoli subsidiary, Computer Associates, and Legato.

In general, the cost and business benefits for implementing online storage are well recognized and well known in the art, and such is documented well within the industry journals, proceedings, and white papers. One such white paper is “Achieving Cost Savings Through a True Storage Management Architecture” published by Tivoli Software of Somers, NY, in January of 2002, which is hereby incorporated by reference for additional understanding of the background of the art.

These systems tend to be very capable in their security mechanisms, processes, and schemes. This drives the definition of many “security settings” which define the security implementation of a particular storage server. These security settings are typically configured manually by a system administrator, such as during an installation process or update process. Sometimes, a baseline of these settings may be inherited from another system by “cloning” the system (e.g. copying the system configuration files) from an existing system, often following which some settings are modified by a system administrator.

For example, in a banking enterprise, certain banking industry norms, standards or regulations must be met in securing online stored data. Additionally, online storage systems may also be subject to manual verification for adherence to company or corporate security policies, as well.

Checking all the security settings manually for each and every online storage server within an enterprise may consume a burdensome number of personnel hours, and may be prone to error and incomplete verification.

During such a verification of a system's security settings, each administrator must read the relevant security policies, interpret the meaning of the provisions of the policies, access each of the settings, and verify these security settings on their servers manually. Further complicating this process is that, in many cases, security settings must be accessed through a number of user interfaces and processes such as file editors, administrator's consoles, etc.

Thus, this process is costly and error prone due to the time required for a thorough check, number of online storage servers to be checked, and due to each user or system owner having their own interpretation of the security requirements.

We have recognized a need for a tool which assists and automates checking these security settings according to corporate and/or industry policies or standards. Further, we have recognized a need for a tool which automatically adjusts security parameters for online storage systems to be in compliance with such standards and policies, and to notify system administrators of such changes.

### BRIEF DESCRIPTION OF THE DRAWINGS

The following detailed description when taken in conjunction with the figures presented herein provide a complete disclosure of the invention.

FIG. 1 depicts a generalized computing platform architecture, such as a personal computer, server computer, personal digital assistant, web-enabled wireless telephone, or other processor-based device.

FIG. 2 shows a generalized organization of software and firmware associated with the generalized architecture of FIG. 1.

FIG. 3 illustrates the arrangement of systems and components for use of our tool directly on a storage server or remotely through a administrative client interface.

FIG. 4 sets forth an embodiment of a logical process performed by our tool.

FIG. 5 provides a high level view of storage management.

FIG. 6 shows details of the architecture of IBM's TSM product.

### SUMMARY OF THE DISCLOSURE

Our tool which automates checking and adjusting the security settings of online storage systems according to one or more security policies allows saving time and cost of system administration personnel, and ensures all checks are performed consistently and thoroughly on all servers without subjective manual interpretation of security policies. A more advanced embodiment allows for automatic adjustment of parameters and settings which are found to be out of specification with the security policy to bring them into compliance.

### DETAILED DESCRIPTION

Our tool automatically checks the security settings and parameters on each networked online storage server utilizing a consistent security policy implementation. The security policy implementation is user-configurable for specific environments without necessarily changing the interpretation of the actual check. In one possible realization, our tool is an executable program for a commercially available online storage management product such as IBM's ADSM and TSM running on the AIX or Microsoft Windows NT operating systems, and is controlled by a configuration file which is read upon program startup. Alternate embodiments, however, may run under any suitable operating system such as, but not limited to, HP/UX, Linux, Macintosh, Novell Netware, S/390, OS/400, SGI IRIX UNIX, Sun Solaris, Tru64 UNIX, and Windows XP/ME/2000/98/95/6.x, NUMA-Q PTX, on platforms including but not limited to personal computers, mainframes, workstations, enterprise servers, web servers, and potentially suitably capable portable computing devices such as personal digital assistants, data-networked wireless telephones, and handheld personal computers or “pocket PC's”.

One embodiment, which is detailed further in this disclosure, provides security parameter checking using the system “calls” allowed by the IBM ADSM/TSM software. In other embodiments such as use with other storage server products, system calls, interfaces, dynamic link libraries, objects, or inline coding techniques may be used to realize the functionality and methods of our tool.

High Level View of Storage Management

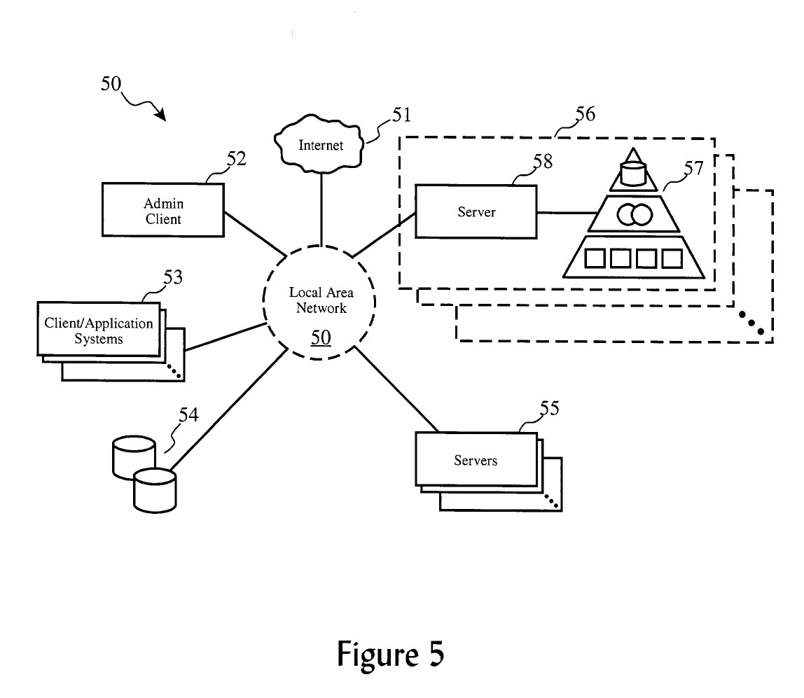

FIG. 5 illustrates the functionality and goals of storage management (50) products such as those previously discussed. In particular, IBM's TSM product protects an organization's data from hardware failures and other types of errors by storing backup and archive copies of date on offline storage. The scalable system can be employed to protect hundreds of computers (53), servers (55, 58), file systems (57), and databases (54), which may include a wide variety of hardware platforms, operating systems, and file systems. All of these systems may be networked through a local area network (50) and/or the Internet (51). An administrator client (52) or console is typically used to configure, manage and maintain the functions of the storage management system.

As such, storage management systems can provide centralized comprehensive data management, support of a broad array of hardware platforms, intelligent data movement and storage, and policy-based automation.

A number of products for suppliers previously mentioned provide storage management platforms and software, all of which are well known in the art. For more information, the publicly available document “IBM Tivoli Storage Manager”, published in April, 2002, by IBM Corporation of Somers, New York, document number G325-6781-00, is hereby incorporated by reference.

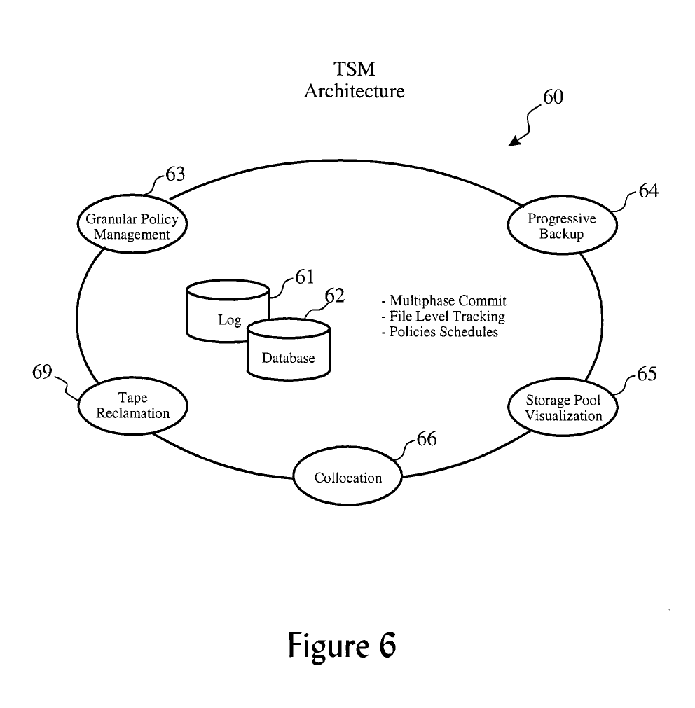

Turning to FIG. 6, an architectural depiction (60) of the TSM product is given. The database (62) and recovery log (61) at the heart of TSM enables several features that help deliver storage efficiencies and lowers cost of operation of the system. Through progressive backup (64) processes, the amount of data transferred over the network is minimized, less data is archived, and a smaller backup window is required. The granular policy management (63) functions allow the system functions to be tailored to each enterprise's business requirements, and to reduce hardware and administration costs.

Tape reclamation (67) functions provide savings in tape capacity and fast restoration of tape-stored data. Fast restoration is also supported by the collocation (66) function through non-redundant data transfer. Storage pool visualization (65) also assists with fast data restoration, as well as provides for high data throughput and storage resource use efficiency.

Other storage management systems may provide some or all of the functions, to a greater or lesser degree, with more or less flexibility and configurability. As such, the logical processes of our tool may be beneficially utilized with other storage management systems, as well.

General High Level Design of Our Security Checking Tool

In one embodiment, our tool is realized using C++ to render an executable program using a common tool library to provide standard input and report output. In other embodiments, the tool may be realized using other high level languages (“HLL”), object-oriented methodologies, or even in hardware circuitry (e.g. dedicated application specific integrated circuits).

On a Windows NT-based system, the tool can be run remotely from an administrative client machine which is networked to any storage management server, independent of the hardware platforms of the server and client. On an AIX-based system, it is recommended that the tool be run directly on the storage server host system, as several security parameter checks consist of checking file permissions on the host system (a function not usually provided to remote admin consoles).

The tool is typically protected from unauthorized use through requirement of a valid administrative ID and password to invoke or start the process. On an AIX system, the program should be run as a root process, and on a Windows NT system, run as an administrative ID. In some embodiments, a separate ID and password may also be required to access the storage management system and it's data files, components, and parameters. This separate storage management system ID and password may be stored in a protected file for use by the tool in order to streamline use of our tool, and a configuration file for the tool may contain a location and name for the protected file. password.

Computing Platform Details

It is useful to review a generalized architecture of a computing platform which may span the range of implementation, from a high-end web or enterprise server platform, to a personal computer, to a portable PDA or web-enabled wireless phone.

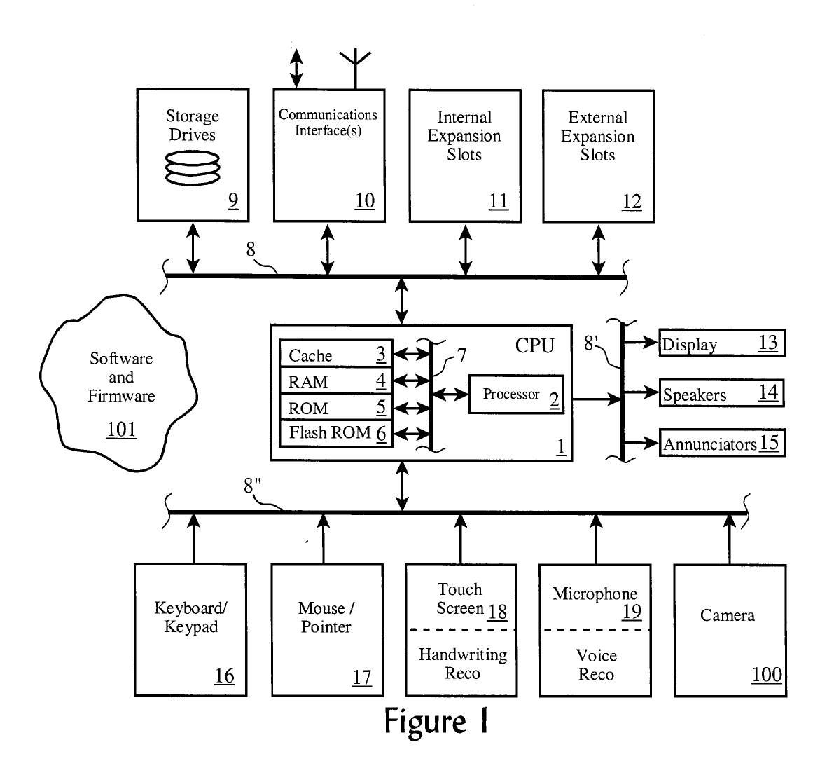

Turning to FIG. 1, a generalized architecture is presented including a central processing unit (1) (“CPU”), which is typically comprised of a microprocessor (2) associated with random access memory (“RAM”) (4) and read-only memory (“ROM”) (5). Often, the CPU (1) is also provided with cache memory (3) and programmable FlashROM (6). The interface (7) between the microprocessor (2) and the various types of CPU memory is often referred to as a “local bus”, but also may be a more generic or industry standard bus.

Many computing platforms are also provided with one or more storage drives (9), such as a hard-disk drives (“HDD”), floppy disk drives, compact disc drives (CD, CD-R, CD-RW, DVD, DVD-R, etc.), and proprietary disk and tape drives (e.g., Iomega Zip [TM] and Jaz [TM], Addonics SuperDisk [TM], etc.). Additionally, some storage drives may be accessible over a computer network.

Many computing platforms are provided with one or more communication interfaces (10), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (IrDA) interface, too.

Computing platforms are often equipped with one or more internal expansion slots (11), such as Industry Standard Architecture (ISA), Enhanced Industry Standard Architecture (EISA), Peripheral Component Interconnect (PCI), or proprietary interface slots for the addition of other hardware, such as sound cards, memory boards, and graphics accelerators.

Additionally, many units, such as laptop computers and PDA's, are provided with one or more external expansion slots (12) allowing the user the ability to easily install and remove hardware expansion devices, such as PCMCIA cards, SmartMedia cards, and various proprietary modules such as removable hard drives, CD drives, and floppy drives.

Often, the storage drives (9), communication interfaces (10), internal expansion slots (11) and external expansion slots (12) are interconnected with the CPU (1) via a standard or industry open bus architecture (8), such as ISA, EISA, or PCI. In many cases, the bus (8) may be of a proprietary design.

A computing platform is usually provided with one or more user input devices, such as a keyboard or a keypad (16), and mouse or pointer device (17), and/or a touch-screen display (18). In the case of a personal computer, a full size keyboard is often provided along with a mouse or pointer device, such as a track ball or TrackPoint [TM]. In the case of a web-enabled wireless telephone, a simple keypad may be provided with one or more function-specific keys. In the case of a PDA, a touch-screen (18) is usually provided, often with handwriting recognition capabilities.

Additionally, a microphone (19), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (100), such as a still digital camera or full motion video digital camera.

One or more user output devices, such as a display (13), are also provided with most computing platforms. The display (13) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (14) and/or annunciators (15) are often associated with computing platforms, too. The speakers (14) may be used to reproduce audio and music, such as the speaker of a wireless telephone or the speakers of a personal computer. Annunciators (15) may take the form of simple beep emitters or buzzers, commonly found on certain devices such as PDAs and PIMs.

These user input and output devices may be directly interconnected (8′, 8″) to the CPU (1) via a proprietary bus structure and/or interfaces, or they may be interconnected through one or more industry open buses such as ISA, EISA, PCI, etc.

The computing platform is also provided with one or more software and firmware (101) programs to implement the desired functionality of the computing platforms.

This computing platform may represent in a general manner the computer for running or executing our tool which may be an executable program, or for hosting an application specific circuit. As our tool is potentially used on a remote client computer or directly on a storage server computer, this generalized architecture of a computing platform represents either server or client system, or both.

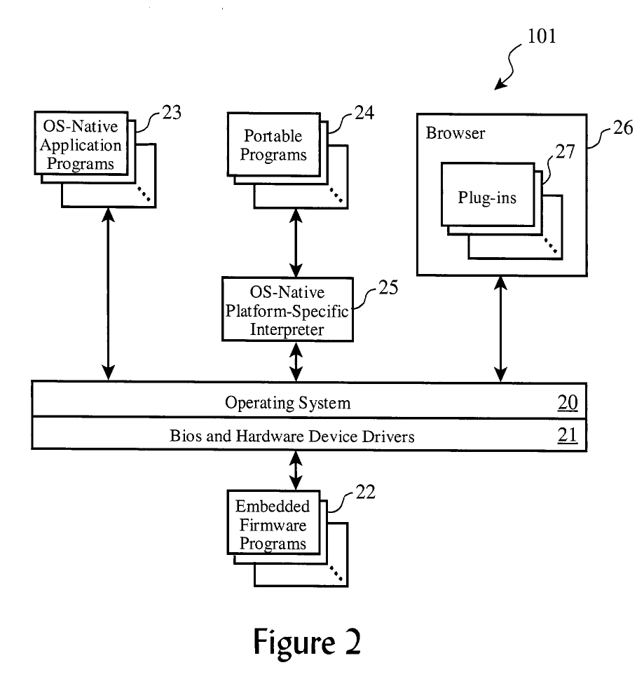

Turning to now FIG. 2, more detail is given of a generalized organization of software and firmware (101) on this range of computing platforms. One or more operating system (“OS”) native application programs (23) may be provided on the computing platform, such as word processors, spreadsheets, contact management utilities, address book, calendar, email client, presentation, financial and bookkeeping programs.

Additionally, one or more “portable” or device-independent programs (24) may be provided, which must be interpreted by an OS-native platform-specific interpreter (25), such as Java [TM] scripts and programs.

Often, computing platforms are also provided with a form of web browser or microbrowser (26), which may also include one or more extensions to the browser such as browser plug-ins (27).

The computing device is often provided with an operating system (20), such as Microsoft Windows [TM], UNIX, IBM OS/2 [TM], LINUX, MAC OS [TM] or other platform specific operating systems. Smaller devices such as PDA's and wireless telephones may be equipped with other forms of operating systems such as real-time operating systems (“RTOS”) or Palm Computing's PalmOS [TM].

A set of basic input and output functions (“BIOS”) and hardware device drivers (21) are often provided to allow the operating system (20) and programs to interface to and control the specific hardware functions provided with the computing platform.

Additionally, one or more embedded firmware programs (22) are commonly provided with many computing platforms, which are executed by onboard or “embedded” microprocessors as part of the peripheral device, such as a micro controller or a hard drive, a communication processor, network interface card, or sound or graphics card.

As such, FIGS. 1 and 2 describe in a general sense the various hardware components, software and firmware programs of a wide variety of computing platforms, including but not limited to personal computers, PDAs, PIMs, web-enabled telephones, and other appliances such as WebTV [TM] units. We now turn our attention to disclosure of embodiment of our tool, its processes and methods which

Storage and Administrative System Components

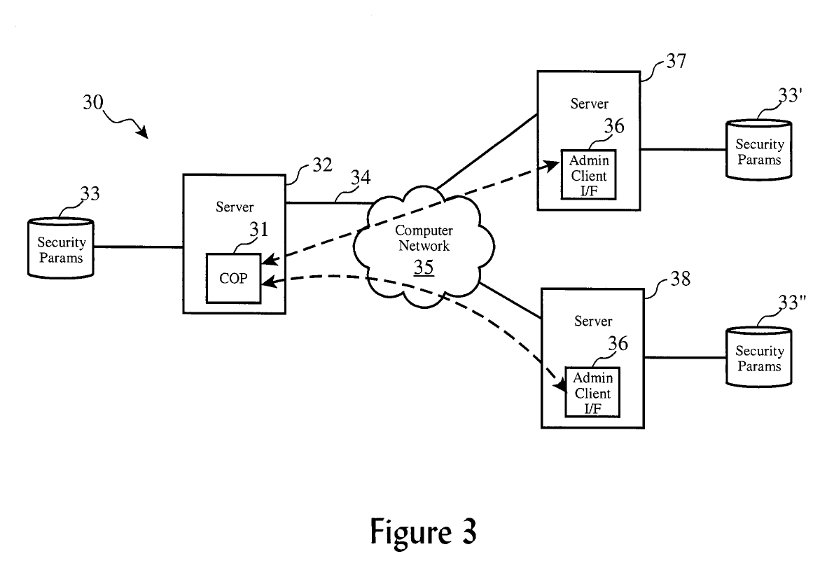

Turning to FIG. 3, the general arrangement of system components including our tool is shown. One or more servers (32, 37, 38, 39) are internetworked via a computer network (35), such as an Intranet or the Internet. On some servers (37, 38, 39) a remote administrator's interface (36) may be provided to allow administrative functions such as security setting inspection and changing to be performed remotely by a remote client. Each of the servers has one or more security parameters (33, 33′, 33″, 33″′), such as parameters stored in configuration files, initialization files, etc.

Our tool (31), referred to as “COP”, may run on a remote system (32) or directly on a storage server (39). If running on a remote system, our tool communicates (as shown with dotted lines) to the remote administrator's interface (36) on the storage server to access security parameters (33′, 33″). If running directly on a storage server (39), our tool (13) may access the locally stored security parameters (33″′) via the application programming interface (“API”) provided by the local administrative client interface (36).

General Process of Our Tool

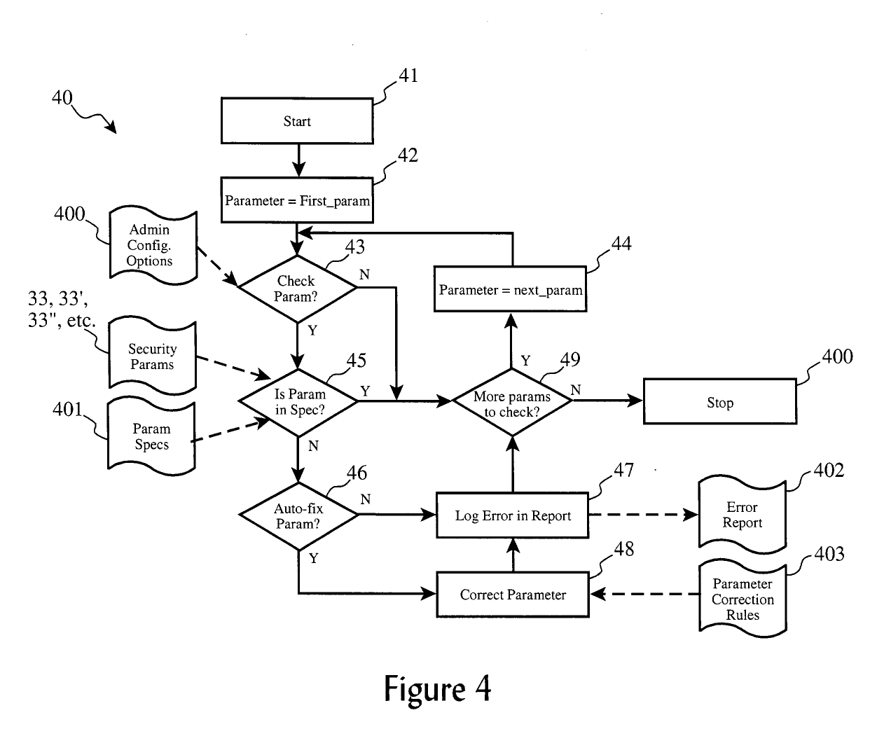

One embodiment (40) of the general process or method of our tool is depicted in FIG. 4. The tool is started (41) through any number of actions or events, including invocation by a user, timed execution, even driven execution, and the like. The tool then starts with a first security parameter to be checked (42, 43) as determined by a tool configuration option (400). If this parameter is to be checked (43), the relevant security parameter (33, 33′, 33″, . . . ) is retrieved (either locally or remotely), and compared (45) to a parameter specification (401) such as an allowed logical value, range of values, or condition.

If the parameter is within specification or allowable value and more parameters are to be check (49), then the next parameter is subjected to the same sequence of retrieval and comparison (44, 43, 45).

If the parameter is not within specification or allowable value (46), then an error is logged (47) to a report to notify an administrator of the noncompliance in an error report (402). Additionally, if configured to do so (46), the tool may correct (48) the noncompliance by executing a system administrator's command to change the setting to an acceptable value or condition. A set of rules for correction of parameters (403) may be provided to allow more sophisticated security parameter correction functions, such as:

(a) If parameter is greater than maximum allowed value (e.g. max login tries, max time to respond, etc.), then set parameter to maximum allowed value per policy or specification;

(b) If parameter is less than minimum allowed value (e.g. min password characters) then set parameter to minimum allowed value per policy or specification;

(c) If logical parameter is not equal to allowable condition (e.g. password login not required or disabled), then set parameter to condition allowed per policy or specification; etc.

The fact that the tool has modified a security parameter may also be logged (47) in the error report (402) such that the tool user may be notified of the changes made. When all parameters have been checked (49), the process may stop (400).

Accessing Storage System Security Settings

One method of accessing a storage system's security settings is through use of system administrator's commands which would normally display the settings on the administrator's console or display. Instead, however, the output of the system commands are redirected or “piped” into and output file, which can then be opened and read by the tool's analysis process.

In other embodiments of our tool, the security parameters to be checked may be directly accessed through file operations, examining a report generated by an administrator command, other available storage system interfaces and remote procedure calls. Combinations of all of these methods may also be employed.

Example Security Parameters Checked and Optionally Corrected

The following security parameters for TSM systems may be checked and corrected by our tool. These TSM-specific parameters are provided to illustrate the types and kinds of parameters which may also be checked and corrected by our tool in alternate embodiments with alternate storage management products. As such, the following set of examples of security parameters is not exhaustive, and the ability of our tool to check and correct security parameters according to security policies and correction rules is not limited to the examples provided herein.

(a) Authentication parameter (Authentication Tickets/Tokens)

Policy/Rule: Client/server password authentication must never be set to condition X, where condition X is an administrator configurable value of ON or OFF.

Check and correct parameter process:

(1) run system command “/usr/bin/dsmadmc−id=$ADMID−password=$ADMPW−command select AUTHENTICATION from STATUS”

(2) pipe output to an output file, which will contain a string such as “ANS8000I Server command: ‘select authentication from status’ Y”

(3) parse this output string and verify the value is equal to X

(4) If value is not an allowed value, report nonconformance

(5) If auto-correction enabled, run system command “SET A UTHENTICA TION X” and report change in value

(b) Minimum Password Length Parameter

Policy/Rule: Minimum password length of X characters, where X is an administrator configurable value between 0 and 64

Check and correct parameter process:

(1) For each storage server, perform the following actions:

(2) run system command “/usr/bin/dsmadmc−id=$ADMID−password=$ADMP W−command select MINPWLENGTH from STATUS”

(3) pipe output to an output file, which will contain a string such as “ANS8000I Server command: ‘select minpwlength from status’ Y”

(4) parse this output string and verify the value Y is greater than or equal to the rule value X;

(5) If value is not an allowed value, report nonconformance

(6) If auto-correction enabled, run system command “SET MINPWLENGTH X” and report change in value

(c) Invalid Password Attempts

Policy/Rule: UserID's must be locked after X failed password attempts to use that UserID, where X is an administrator-configured value between 0 and 9999, X=0 disables UserID locking regardless of number of failed password attempts, and X=1 locks a UserID upon one failed password attempt

Check and correct parameter process:

(1) For each storage server, perform the following actions:

(2) run system command “/usr/bin/dsmadmc−id=$ADMID−password=$ADMPW−command select INVALIDPWLIMIT from STATUS”

(3) pipe output to an output file, which will contain a string such as “ANS8000I Server command: ‘select invalidpwlimit from status’ Y”

(4) parse this output string and verify the value Y is greater than or equal to the rule value X;

(5) If value is not an allowed value, report nonconformance

(6) If auto-correction enabled, run system command “SET INVALIDPWLIMITX” and report change in value

(d) Password Expiration Period

Policy/Rule: Passwords should expire within X days or less, where X is an administrator-configured value between 0 and 9999, X=0 disables password expiration (e.g. passwords a valid forever)

Check and correct parameter process:

(1) For each storage server, perform the following actions:

(2) run system command “/usr/bin/dsmadmc−id=$ADMID−password=$ADMP W−command select PASSEXP from STATUS”

(3) pipe output to an output file, which will contain a string such as “ANS8000I Server command: ‘select passexp from status’ Y”

(4) parse this output string and verify the value Y is less than or equal to the rule value X;

(5) If value is not an allowed value, report nonconformance

(6) If auto-correction enabled, run system command “SET PASSEXP X” and report change in value

(e) Activity Log Existence and Retention

Policy/Rule: Activity logs should be retained for a minimum of X days, where X is an administrator-configured value between 0 and 9999, X=0 disables activity log retention.

Check and correct parameter process:

(1) For each storage server, perform the following actions:

(2) run system command “/usr/bin/dsmadmc−id=$ADMID−password=$ADMP W−command select ACTLOGRETENTION from STATUS”

(3) pipe output to an output file, which will contain a string such as “ANS8000I Server command: ‘select actlogretention from status’ Y”

(4) parse this output string and verify the value Y is greater than or equal to the rule value X;

(5) If value is not an allowed value, report nonconformance

(6) If auto-correction enabled, run system command “SET ACTLOGRETENTION X” and report change in value

(f) Activity Logging with Security Administrative or System Authority

Policy/Rule: Sending messages to the issuing administrative console for activities performed using security administrative or system authority should always be X, where X is an administrator configurable condition having the value ON (enabled) or OFF (disabled).

Check and correct parameter process:

(1) run system command “/usr/bin/dsmadmc−id=$ADMID−password=$ADMPW−command select ACCOUTING from STATUS”

(2) pipe output to an output file, which will contain a string such as “ANS8000I Server command: ‘select accounting from status’ Y”

(3) parse this output string and verify the value is equal to X

(4) If value is not an allowed value, report nonconformance

(5) If auto-correction enabled, run system command “SET ACCOUNTING X” and report change in value

Other storage system security parameters may be interrogated, evaluated and corrected, as indicated by each storage system's options, including the file read/write/modify permissions, operating system resources, etc. For parameters which are not directly comparable to an integer value or Boolean value, such as bit-mapped parameters, executable code may be used to extract and test the value of specific bits, and to set or clear specific bits within the parameter.

Conclusion

The background of the art, summary of the invention, abstract, and detailed description have been disclosed with a variety of embodiment options, and with specific reference to a selected storage management software product. It will be readily recognized by those skilled in the art that these details are provided for illustration and understandability of the invention, and that the scope of the invention is not limited to these embodiment details but is defined by the following claims.

What is claimed is:

1. A method in a storage management system comprising:
accessing one or more security parameters of said storage management system;
evaluating said security parameters against a set of security policies, rules and allowable parameter values; and
indicating in a user-readable report which security parameters fail to meet said security policies, rules and allowable parameter values.

2. The method as set forth in claim 1 wherein said step of indicating parameters which fail also comprises indicating which parameters meet or exceed said security policies, rules and allowable parameter values.

3. The method as set forth in claim 1 further comprising modifying security parameter values which fail to meet said security policies, rules and allowable parameter values to bring said parameter values into compliance.

4. The method as set forth in claim 3 further comprising indicating in a user-readable report which security parameters have been modified to bring them into compliance.

5. The method as set forth in claim 1 wherein said step of accessing one or more security parameters comprises accessing security parameters through an administration client interface.

6. The method as set forth in claim 1 wherein said step of accessing one or more security parameters comprises accessing one or more parameters selected from the group of minimum allowable password length, maximum allowable failed password attempts, maximum allowable password expiration time, activity logging enablement, minimum activity log entry retention time, secure administrator activity logging enablement, and system administrator activity logging enablement.

7. The method as set forth in claim 1 wherein said step of accessing one or more security parameters comprises accessing parameters using a method selected from the group of executing an administrator console command, redirecting a displayed parameter to a computer readable media, accessing a computer readable media, examining a computer readable report, and operating an administrative function interface for a storage management product.

8. The method of claim 1 wherein said storage management system is a Tivoli Storage Management system.

9. The method of claim 1 wherein said storage management system is an ADSTAR Storage Management System.

10. A system comprising:
one or more accessible security settings associated with a storage management system;
a security setting retriever operative to access said security settings;
a policy defining one or more acceptable values for security settings;
a setting comparitor which evaluates said retrieved security settings against said policy; and
a report generator operative to produce a user-readable report with indications of security settings which do not comply with said policy.

11. The system as set forth in claim 10 wherein said report generator is further operative to indicate which settings which comply with said security policy

12. The system as set forth in claim 10 further comprising a setting modifier operative to change noncompliant security settings to a compliant value.

13. The system as set forth in claim 12 wherein said report generator is further operative to indicate which security settings have been modified.

14. The system as set forth in claim 10 wherein said security setting retriever is operative to access security settings through an administration client interface.

15. The system as set forth in claim 10 wherein said security setting retriever is operative to access security settings selected from the group of minimum allowable password length, maximum allowable failed password attempts, maximum allowable password expiration time, activity logging enablement, minimum activity log entry retention time, secure administrator activity logging enablement, and system administrator activity logging enablement.

16. The system as set forth in claim 10 wherein said security setting retriever is operative to access security settings using a method selected from the group of executing an administrator console command, redirecting a displayed parameter to a computer readable media, accessing a computer readable media, examining a computer readable report, and operating an administrative function interface for a storage management product.

17. The system of claim 10 wherein said security settings are associated with a Tivoli Storage Management system.

18. The system of claim 10 wherein said security settings are associated with an ADSTAR Storage Management System.

19. A computer readable media encoded with software for performing the steps of:
accessing one or more security parameters of said storage management system;
evaluating said security parameters against a set of security policies, rules and allowable parameter values; and
indicating in a user-readable report which security parameters fail to meet said security policies, rules and allowable parameter values.

20. The media as set forth in claim 19 wherein said software for indicating parameters which fail also comprises software for indicating which parameters meet or exceed said security policies, rules and allowable parameter values.

21. The media as set forth in claim 19 further comprising software for modifying security parameter values which fail to meet said security policies, rules and allowable parameter values to bring said parameter values into compliance.

22. The media as set forth in claim 21 further comprising software for indicating in a user-readable report which security parameters have been modified to bring them into compliance.

23. The media as set forth in claim 19 wherein said software for accessing one or more security parameters comprises software for accessing security parameters through an administration client interface.

24. The media as set forth in claim 19 wherein said software for accessing one or more security parameters comprises software for accessing one or more parameters selected from the group of minimum allowable password length, maximum allowable failed password attempts, maximum allowable password expiration time, activity logging enablement, minimum activity log entry retention time, secure administrator activity logging enablement, and system administrator activity logging enablement.

25. The media as set forth in claim 19 wherein said software for accessing one or more security parameters comprises software for accessing parameters using a method selected from the group of executing an administrator console command, redirecting a displayed parameter to a computer readable media, accessing a computer readable media, examining a computer readable report, and operating an administrative function interface for a storage management product.

26. The media of claim 19 wherein said security parameters are associated with a Tivoli Storage Management system.

27. The media of claim 19 wherein said security parameters are associated with an ADSTAR Storage Management System.
